(19) United States
(12) Patent Application Publication
(10) Pub. No.: US 2021/0406333 A1
(43) Pub. Date: Dec. 30, 2021

(54) CAUSAL SELECTION PREFERENCES

(71) Applicant: Google LLC, Mountain View, CA (US)

(72) Inventor: Bryan C. Horling, Sunnyvale, CA (US)

(21) Appl. No.: 17/048,886

(22) PCT Filed: Mar. 18, 2019
(86) PCT No.: PCT/US2019/022726

§ 371 Date: Oct. 19, 2020

(51) Int. Cl. G06F 16/9538

(52) U.S. Cl. CPC G06F 16/9538

(57) ABSTRACT

Methods, systems, and apparatus, including computer programs encoded on a computer storage medium, for accessing data that indicates selection preferences of a particular user, determining, first and second data sets of content items for presentation, generating a first display panel that will cause a user device to display the first data set of the first content items, generating a second display panel that will cause the user device to display the second data set of the second content items, providing, to the user device, the first display panel and the second display panel for simultaneous display on the user device, providing, to the user device, data that displays a request to select one of the first display panel or the second display panel, and receiving, from the user device, data indicating a selection of one of the first display panel or the second display panel.

### BACKGROUND

User devices provide access to a wide variety of information. For example, digital image files, video and/or audio files, as well as resources for particular subjects or particular news articles, are accessible over the Internet. This information may be viewed in web browsers running on a user device and native applications running on a user device. Search engines crawl and index these resources to facilitate searching of the resources. Thus, for just about any subject in which a user may be interested, there is a large amount of information that is readily available to the user.

Search engines can provide to a user content that is ranked, in part, on user preferences of the user. Periodically a search engine provider may desire to evaluate the efficacy of providing content adjusted in such a manner, or may desire surfacing the capability of providing such adjusted content to a user.

### SUMMARY

This specification describes technologies relating to systems and methods for determining selection preferences for a user of a user device. The subject matter provides an implementation of generating two different display panels to indicate to the particular user the benefits of using a display panel that is customized based on the selection preferences of the particular user.

In general, one innovative aspect of the subject matter described in this specification can be embodied in methods that include the actions of accessing data that indicates selection preferences of a particular user, determining, independent of the selection preferences of the particular user, a first data set of first content items for presentation to the particular user, determining, dependent on the selection preferences of the particular user, a second data set of second content items for presentation to the particular user, wherein the second data set includes at least one second content item that has a ranking in the second data set that is boosted relative to a ranking that would have resulted independent of the selection preferences, and is determined to be a content item that the particular user will select, generating a first display panel that will cause a user device to display the first data set of the first content items, generating a second display panel that will cause the user device to display the second data set of the second content items, providing, to the user device, the first display panel and the second display panel for simultaneous display on the user device, wherein the simultaneous display is a juxtaposition of the first display panel and the second display panel, providing, to the user device, data that displays a request to select one of the first display panel or the second display panel, and receiving, from the user device, data indicating a selection of one of the first display panel or the second display panel. Other embodiments of this aspect include corresponding systems, apparatus, and computer programs, configured to perform the actions of the methods, encoded on computer storage devices.

These and other embodiments can each optionally include one or more of the following features. In some aspects, accessing data that indicates selection preferences of the particular user includes determining that preference data specifying selection preferences of the particular user are available, and in response to determining that the preference data specifying selection preferences of the particular user are available, accessing the preference data.

In some aspects, accessing data that indicates selection preferences of the particular user includes determining that preference data specifying selection preferences of the particular user are not available, and in response accessing user activity data from a current user session for the particular user, the user activity data specifying activities of the user, accessing user activity data from user sessions for a plurality of other users, comparing the user activity data from the current user session for the particular user to the user activity data for the plurality of other users, and generating proxy selection preferences for the particular user based on the selection preferences of other users for which the user activity data for the other users meet a similarity threshold to the user activity data from the current user session based on the comparison.

In some aspects, accessing data that indicates selection preferences of the particular user includes determining that preference data specifying selection preferences of the particular user are not available, and in response accessing user activity data from a current user session for the particular user, the user activity data specifying keywords input by the user, and generating, based on the keywords, selection data that indicates selection preferences for the particular user.

In some aspects, determining that the at least one second content item is a content item that the particular user will select is based on data indicating prior selections of the particular user. In some aspects, determining that the at least one second content item is a content item that the particular user will select is based on data indicating prior selections of other users that have respective search histories that meet a similarity threshold to a search history of the particular user.

In some aspects, the data that indicates selection preferences of the particular user is based on location data. In some aspects, the data that indicates selection preferences of the particular user is based on web history data. In some aspects, the data that indicates selection preferences of the particular user is based on search history data.

In some aspects, in response to receiving, from the user device, data indicating the selection of the second display panel, providing, to the user device, data that displays an indication that the second display panel is based on the selection preferences of the particular user.

In general, another innovative aspect of the subject matter described in this specification can be embodied in a system that includes a data processing apparatus, and a non-transitory computer readable storage medium in data communication with the data processing apparatus and storing instructions executable by the data processing apparatus and upon such execution cause the data processing apparatus to perform operations. The operations include accessing data that indicates selection preferences of a particular user, determining, independent of the selection preferences of the particular user, a first data set of first content items for presentation to the particular user, determining, dependent on the selection preferences of the particular user, a second data set of second content items for presentation to the particular user, wherein the second data set includes at least one second content item that has a ranking in the second data set that is boosted relative to a ranking that would have resulted independent of the selection preferences, and is determined to be a content item that the particular user will select, generating a first display panel that will cause a user device to display the first data set of the first content items, generating a second display panel that will cause the user device to display the second data set of the second content items, providing, to the user device, the first display panel and the second display panel for simultaneous display on the user device, wherein the simultaneous display is a juxtaposition of the first display panel and the second display panel, providing, to the user device, data that displays a request to select one of the first display panel or the second display panel, and receiving, from the user device, data indicating a selection of one of the first display panel or the second display panel. Other embodiments of this aspect include corresponding systems, apparatus, and computer programs, configured to perform the actions of the methods, encoded on computer storage devices.

In general, another innovative aspect of the subject matter described in this specification can be embodied in a transitory or non-transitory computer storage medium encoded with a computer program, the computer program including instructions that when executed by a data processing apparatus cause the data processing apparatus to perform operations. The operations include accessing data that indicates selection preferences of a particular user, determining, independent of the selection preferences of the particular user, a first data set of first content items for presentation to the particular user, determining, dependent on the selection preferences of the particular user, a second data set of second content items for presentation to the particular user, wherein the second data set includes at least one second content item that has a ranking in the second data set that is boosted relative to a ranking that would have resulted independent of the selection preferences, and is determined to be a content item that the particular user will select, generating a first display panel that will cause a user device to display the first data set of the first content items, generating a second display panel that will cause the user device to display the second data set of the second content items, providing, to the user device, the first display panel and the second display panel for simultaneous display on the user device, wherein the simultaneous display is a juxtaposition of the first display panel and the second display panel, providing, to the user device, data that displays a request to select one of the first display panel or the second display panel, and receiving, from the user device, data indicating a selection of one of the first display panel or the second display panel. Other embodiments of this aspect include corresponding systems, apparatus, and computer programs, configured to perform the actions of any of the methods disclosed herein, encoded on computer storage devices.

Particular embodiments of the subject matter described in this specification can be implemented so as to realize one or more of the following advantages. In some implementations, the system determines a data set of content items for presentation in a display panel to the particular user that is dependent on the selection preferences of the particular user, and determines one or more content items that has a ranking in the data set that is boosted relative to a ranking that would have resulted independent of the selection preferences, where boosting a ranking can include any change in the display items. This provides a quick and computationally-efficient way of selecting a content item for inclusion in the second display panel, whilst causing the second display panel to be noticeably different from the first display panel.

In some implementations, if the system does not have access to the selection preferences of the particular person, the system can access user activity data from a current user session for the particular user, the user activity data specifying activities of the user, and accessing user activity data from user sessions for a plurality of other users. The system compares the user activity data from the current user session for the particular user to the user activity data for the plurality of other users, and generates proxy selection preferences for the particular user based on the selection preferences of other users for which the user activity data for the other users that meet a similarity threshold to the user activity data from the current user session. The threshold may be a fixed threshold, or may be an outlier threshold based on statistics for the action, e.g., greater than one standard deviation from the mean percentage of users that perform actions. This addresses the technical problem of providing adjusted data for a user when user preferences are not available or determined to otherwise not be suitable for determining adjusted data.

Alternatively, or additionally, in some implementations, the technical challenge resulting from the system not having access to the selection preferences of the particular person can also be addressed by accessing user activity data from a current user session for the particular user, the user activity data specifying keywords input by the user, and generating, based on the keywords, selection data that indicates selection preferences for the particular user.

With conventional user interfaces, a user may not know the benefits of a customized presentation of adjusted results from a query based on the user's selection preferences or by accessing user activity data from a current user session for the particular user. An effective user interface enables the user to readily and rapidly access the right data/functionality. The adjustment application of the present system presents two selectable display panels for a user to choose from. For example, a first display panel is generated utilizing selection preferences for a particular user, and a second display panel is generated independent of the selection preferences for the particular user. The adjustment application presents adjusted result elements (e.g., elements based on selection preferences) to the user in the first display panel, and simultaneously displays unadjusted result elements (e.g., elements not based on selection preferences) to the user in the second display panel. Additionally, the second display panel can highlight differences between the two panels, making it easier for the user to see the changes. Thus, the present system enables the user to readily and rapidly access a preferred display panel of either adjusted result elements or unadjusted result elements, particularly on small screen devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search query evaluation and adjustment system can be implemented.

FIG. 2 is a screen shot illustration of an example user interface presenting, from a search query, a first display panel with adjusted result elements and a second display with unadjusted result elements.

FIG. 3 is a flowchart of an example process for using a search query evaluation and adjustment system.

FIG. 4 is a flowchart of another example process for using a search query evaluation and adjustment system.

FIG. 5 is a flowchart of another example process for using a search query evaluation and adjustment system.

FIG. 6 is a block diagram of an example computer system that can be used to implement the methods, systems and processes described in this disclosure.

Like reference numbers and designations in the various drawings indicate like elements.

### DETAILED DESCRIPTION

### Overview

The technology in this patent application is related to systems and methods for generating two different display panels of content items on a user device, where a first display panel is generated utilizing selection preferences for a particular user, and a second display panel is generated independent of the selection preferences for the particular user. The two display panels are simultaneously displayed on the user device, where the simultaneous display is a juxtaposition of each display panel. The different display panels are generated to indicate to the particular user the benefits of using a display panel that is customized based on the selection preferences of the particular user. In some implementations, a selection of one of the first display panel or the second display panel is received from the user device, indicating whether the user preferred the display with selection preferences, or preferred the display without selection preferences.

The second display panel may include one or more content items. The one or more content items may be selected for inclusion in the second display panel based on many parameters, which include—but are not necessarily limited to—the selection preferences of the particular user. Some selection preferences may have a greater influence upon the content items that are selected for inclusion in the second display panel than others. There is thus a technical challenge in selecting a content item to include in the second display panel. More specifically, there is a technical challenge in selecting a content item that is sufficiently influenced by the selection preferences to cause the second display panel to be noticeably different from the first display panel, without the generation of the second display panel being delayed by the amount of processing required to select the content item.

In some implementations, determining a data set of content items for presentation in a display panel to the particular user that is dependent on the selection preferences of the particular user can include determining one or more content items that has a ranking in the data set that is boosted relative to a ranking that would have resulted independent of the selection preferences. This provides a quick and computationally-efficient way of selecting a content item for inclusion in the second display panel, whilst causing the second display panel to be noticeably different from the first display panel. Likewise, determining a data set of content items for presentation in a display panel to the particular user that is dependent on the selection preferences of the particular user can include determining one or more content items that has been added or removed when such one or more content item would not have been added or removed when the content was selected independent of the selection preferences.

In some implementations, boosting a ranking of one or more content items can include any change in the display items. For example, if a list of recipes is shown, including a snippet of each recipe, the system can choose what subset of information to include for each recipe. If the system knows that the user has a preference for a particular ingredient, the personalized item might include that particular ingredient in the snippet or highlight that ingredient, causing a change in display without a change in ordering.

Regarding the selection preferences, the preferences may be those specific to the user, or be proxy preferences based on other users that exhibit a behavior similar to the user. For example, in some implementations, determining that at least one content item is a content item that the particular user will select is based on data indicating prior selections of the particular user. In some implementations, determining that at least one content item is a content item that the particular user will select is based on data indicating prior selections of other users that have respective search histories that meet a threshold of similarity to a search history of the particular user. This further helps in selecting a content item for inclusion in the second display panel quickly and efficiently, whilst causing the second display panel to be noticeably different from the first display panel. The threshold may be a fixed threshold, or may be an outlier threshold based on statistics for the action, e.g., greater than one standard deviation from the mean percentage of users that perform actions.

More specifically, in some implementations, the technology focuses on determining that preference data specifying selection preferences of the particular user are available, and in response accesses the preference data. In some implementations, the subject matter further addresses the technical challenge of determining that the system does not have access to the selection preferences of the particular person. This technical challenge may be addressed by accessing user activity data from a current user session for the particular user, the user activity data specifying activities of the user, and accessing user activity data from user sessions for a plurality of other users. Then after comparing the user activity data from the current user session for the particular user to the user activity data for the plurality of other users, the system can generate proxy selection preferences for the particular user based on the selection preferences of other users for which the user activity data for the other users that meet a similarity threshold to the user activity data from the current user session.

Alternatively, or additionally, in some implementations, the technical challenge of determining that the system does not have access to the selection preferences of the particular person can also be addressed by accessing user activity data from a current user session for the particular user, the user activity data specifying keywords input by the user, and generating, based on the keywords, selection data that indicates selection preferences for the particular user.

In some implementations, the data that indicates selection preferences of the particular user can be based on location data, web history data, search history data, activity data generated through the use of a product, and the like, and any combination of similar data thereof.

In some implementations, the selection preferences are personalization preferences of the particular user. For example, the two different display panels that are generated can indicate to the particular user the benefits of using a display panel that is customized based on the personalization preferences of the particular user.

Periodically a search engine provider may desire to evaluate the efficacy of providing content adjusted in such a manner, or may desire surfacing the capability of providing such adjusted content to a user. To do so, a search engine provider may provide evaluation data to the user and request that the user respond to the evaluation data. The ability to generate the evaluation data, however, needs to be implemented in a manner that is efficient in terms of computing resources. Moreover, the evaluation data that is generated also needs to be evaluation data that can be attributed to user preferences of the particular user.

While the examples below are primarily described in the context of search result content items for a query, the featured described in this application can be applied to the selection many other different types of content item in many different environments. Such recommendations and content items can include recommendations directed to products; news stories surfaced on a news portal, and so on. These features and additional features are described in more detail below.

Example Operating Environment

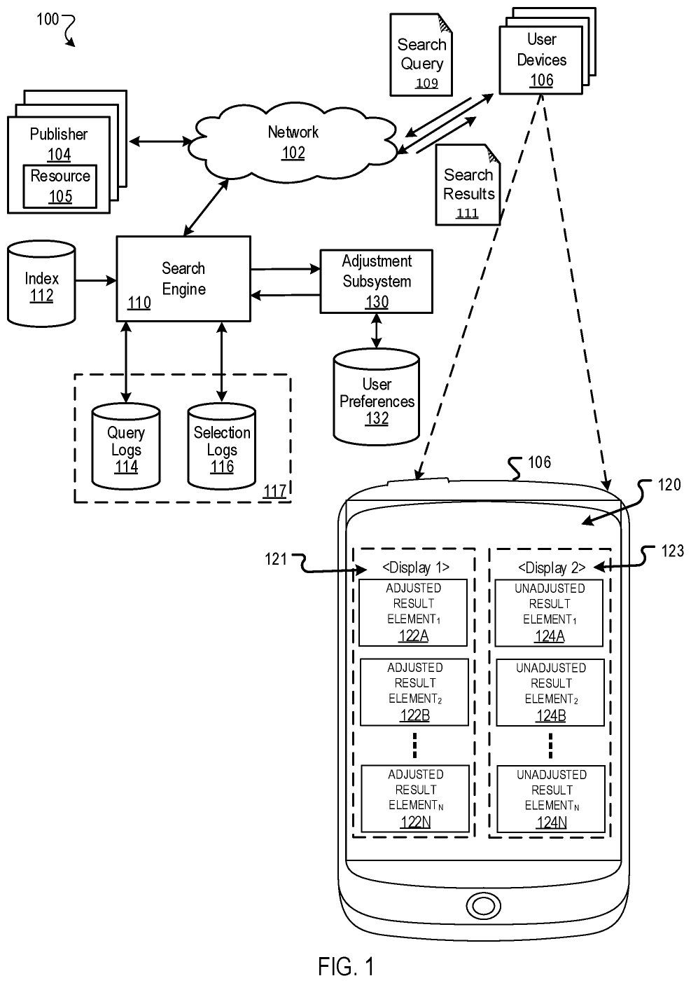

FIG. 1 is a block diagram of an example environment 100 in which an adjustment system can be implemented in a search processing system. A computer network 102, such as a local area network (LAN), wide area network (WAN), the Internet, or a combination thereof, connects publisher web sites 104, user devices 106, and the search engine 110. The online environment 100 may include many thousands of publisher web sites 104 and user devices 106.

A publisher website 104 includes one or more resources 105 associated with a domain name and hosted by one or more servers. An example website is a collection of web pages formatted in hypertext markup language (HTML) that can contain text, images, multimedia content, and programming elements, such as scripts. Each publisher website 104 is maintained by a content publisher, which is an entity that controls, manages and/or owns the publisher website 104.

A resource is any data that is provided by the publisher website 104 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as scripts).

A user device 106 is an electronic device capable of requesting and receiving resources over the network 102. Example user devices 106 include personal computers, mobile communication devices, and other devices that can send and receive data over the network 102. A user device 106 typically includes a user application, such as a web browser or some other application, to facilitate the sending and receiving of data over the network 102. The user device 106 can present media using an application. Media is images, video, audio, text, or some combination of the like that a user consumes using an application running on a user device 106. The web browser can enable a user to display and interact with text, images, videos, music and other information typically located on a web page at a website on the World Wide Web or a local area network.

To facilitate searching of these resources 105, the search engine 110 identifies the resources by crawling the publisher web sites 104 and indexing the resources provided by the publisher web sites 104. The indexed and, optionally, cached copies of the resources, are stored in an index 112.

The user devices 106 submit search queries 109 to the search engine 110. The search queries 109 are submitted in the form of a search request. In response to the search request, the search engine 110 uses the index 112 to identify resources that are relevant to the queries. The search engine 110 identifies the resources in the form of search results 111 and returns the search results to the user devices 106 in search results page resource. A search result is data generated by the search engine 110 that identifies a resource that satisfies a particular search query, and includes a resource locator for the resource. An example search result can include a web page title, a snippet of text extracted from the web page, and the uniform resource locator (URL) of the web page.

The search results are ranked based on scores related to the resources identified by the search results, such as information retrieval (IR) scores, and optionally a separate ranking of each resource relative to other resources (e.g., an authority score). The search results are ordered according to these scores and provided to the user device according to the order.

The user devices 106 receive the search results pages and render the pages for presentation to users. In response to the user selecting a search result at a user device 106, the user device 106 requests the resource identified by the resource locator included in the selected search result. The publisher of the publisher website 104 hosting the resource receives the request for the resource from the user device 106 and provides the resource to the requesting user device 106.

In some implementations, the queries 109 submitted from user devices 106 are stored in query logs 114. Click data for the queries and the web pages referenced by the search results are stored in selection logs 116. The query logs 114 and the selection logs 116 define search history data 117 that include data from and related to previous search requests associated with unique identifiers. The click logs define actions taken responsive to search result elements (e.g., search results, search query suggestions, and search query refinements) provided by the search engine 110. The query logs 114 and selection logs 116 are used to map queries submitted by the user devices to these search result elements and resources they reference (e.g., web pages that were identified for search results) and the actions taken by users. The selection logs 116 and query logs 114 can thus be used by the search engine to determine the sequence of queries submitted by the user devices 106, the actions taken in response to the queries and search result elements, and how often the queries are submitted.

One way to enhance search result elements for a user is to provide adjusted result elements that may be selected for inclusion in a display panel based on many parameters, which include—but are not necessarily limited to—selection preferences of the particular user. Periodically, however, a search engine provider may desire to evaluate the efficacy of providing content adjusted in such a manner, or may desire surfacing the capability of providing such adjusted content to a user. To do so, a search engine provide may provide evaluation data to the user and request that the user respond to the evaluation data. In the examples in this specification, the evaluation data is provided in the form of a first display panel and a second display panel that are simultaneously displayed on the user device. The second display panel displays the unadjusted search result content items resulting from a particular query that are not based on selection preferences, and the first display panels shows adjusted search result content items that are adjusted based on selection preferences of the user. The particular user can compare the two displays of adjusted and unadjusted content items. A particular user may then be informed as to the particular advantages of being presented adjusted results based on the selection preferences of the particular user. An adjustment subsystem 130 is used to generate two display panels simultaneously on the user device 106 of adjusted results in a first display and unadjusted results in a second display. The simultaneous display is a juxtaposition of the first display panel and the second display panel.

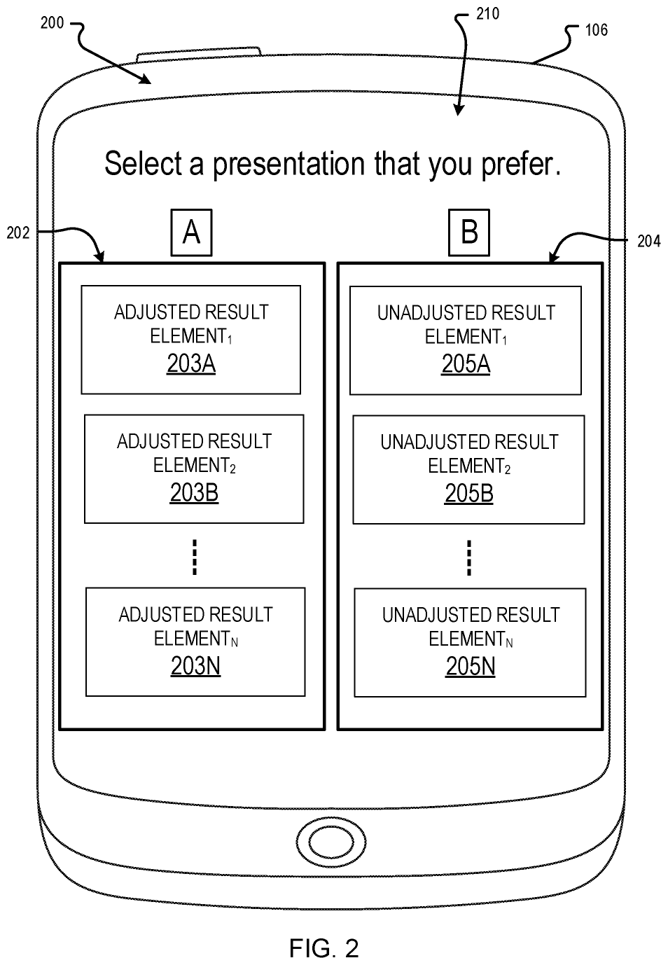

For example, as depicted in FIG. 1, the user device 106 can present adjusted search results in a first display panel 121 and unadjusted search results in a second display panel 123 using an application 120. The search results can include adjusted result elements 122A-122N (hereinafter generally referred to as adjusted result elements 122) in display panel 121. The search results can further include unadjusted result elements 124A-124N (hereinafter generally referred to as unadjusted result elements 124). An example screenshot of a simultaneous display of two display panels for adjusted and unadjusted result elements in a search application for a user device is depicted in FIG. 2.

In some implementations, if the system does not have access to the selection preferences of the particular person stored in the selection logs 116, the system can access user activity data from a current user session for the particular user, the user activity data specifying activities of the user, and accessing user activity data from user sessions for a plurality of other users from the user preferences logs 132. The system compares the user activity data from the current user session for the particular user to the user activity data for the plurality of other users, and generates proxy selection preferences for the particular user based on the selection preferences of other users for which the user activity data for the other users that meet a similarity threshold to the user activity data from the current user session. Additionally, or alternatively, if the system does not have access to the selection preferences of the particular person, the system can access user activity data from a current user session for the particular user, the user activity data specifying keywords input by the user, and generating, based on the keywords, selection data that indicates selection preferences for the particular user.

FIG. 2 depicts a screen shot 200 of an example user interface presenting, from a search query, a first display panel with adjusted result elements and a second display with unadjusted result elements. In the example screen shot 200, after a user performs a search operation in a search application, a user interface 210 of the user device 106 enables a user to select a preferred presentation of results. In particular, the user interface 210 enables the user to choose from a first display panel 202 (i.e., “A”) which includes adjusted results elements 203A-203N which are adjusted based on user selection preferences or other processes described herein, and a second display panel 204 (i.e., “B”) which includes unadjusted results elements 205A-205N. In this example, the application displays to the user, two selectable display panels simultaneously on the user device 106 of adjusted result elements 203 in a first display panel 202 and unadjusted result elements 205 in the second display panel 204. The simultaneous display is shown as a juxtaposition of the first display panel and the second display panel.

In this example, the adjustment subsystem 130 generates two options for the user to select which display panel he or she prefers based on the result elements within each. In particular, as shown in FIG. 2, the system prompts the user with the statement “Select a presentation that you prefer,” while showing display panel 202 as option A (e.g. adjusted result elements 203), and display panel 204 as option B (e.g. unadjusted result elements 205). For example, the user may prefer the adjusted result elements because they appear to be related to the particular selection preferences of the user. The adjusted result elements 203 have been adjusted, by the adjustment subsystem 130, based on either the selection preferences of the particular user, or by accessing user activity data from a current user session for the particular user. The system receives a selection of one of the display panels 202, 204, where the user is selecting the particular display panel the user prefers. The user interface 210 will then display only that particular display panel and remove the other display panel. Thus, if the user does prefer the adjusted results, after receiving a selection from the user for the display panel 202 labeled “A”, the user interface 210 would then remove the display panel 204, and simply present the adjusted result elements 203A-203N in a full screen mode, or a similar display manner. According to some implementations, different icons may be used to signify the above referenced indicators (e.g., “A”, “B” boxes), and different icons may be used for different user actions.

The simultaneous display as shown in FIG. 2 may be done according to a triggering process. For example, one trigger may be when a user receives content items and has not opted into receiving the content items ranking on user preferences. This can be done periodically, e.g., once every month, until a user decides to receive content items ranked accordingly, or decides to permanently opt out of receiving content items according to the adjusted ranking. Another triggering process is the periodic evaluation of ranking on user preferences. For example, assuming a user is receiving content items ranked on user preferences, the system may present the dual display of FIG. 2 every two months to evaluate the efficacy of the adjusted content for the user. Other criteria for providing the dual display can also be used.

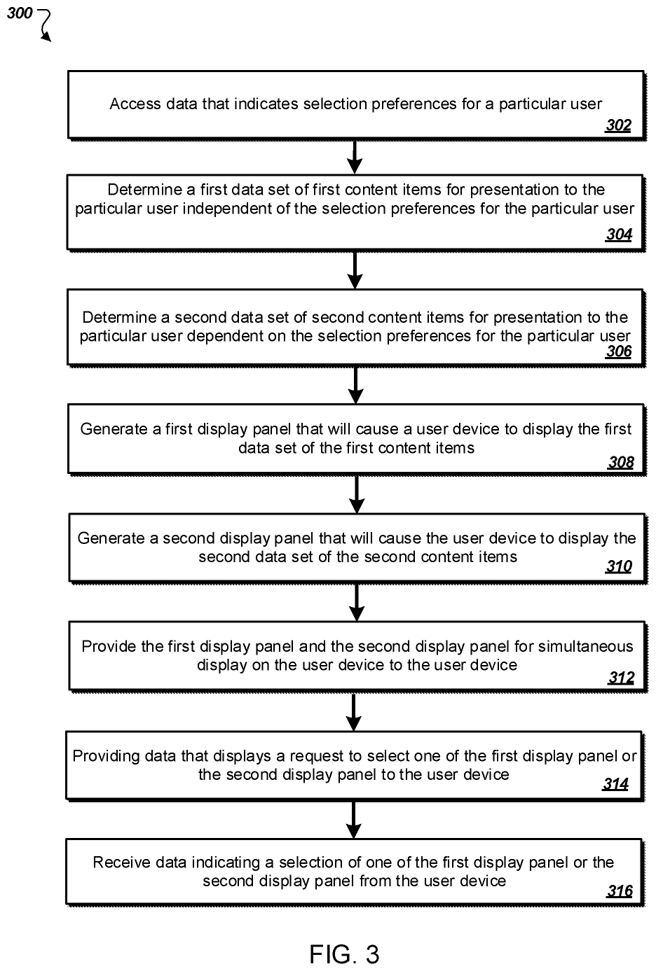

Generating two display panels simultaneously with adjusted and unadjusted search result elements is now described with reference to FIGS. 3-5 below.

Utilization of Selection Preferences Process

FIG. 3 is a flow diagram of an example process 300 for using a search query evaluation and an adjustment system. The process 300 is implemented, for example, by the adjustment subsystem 130 of FIG. 1.

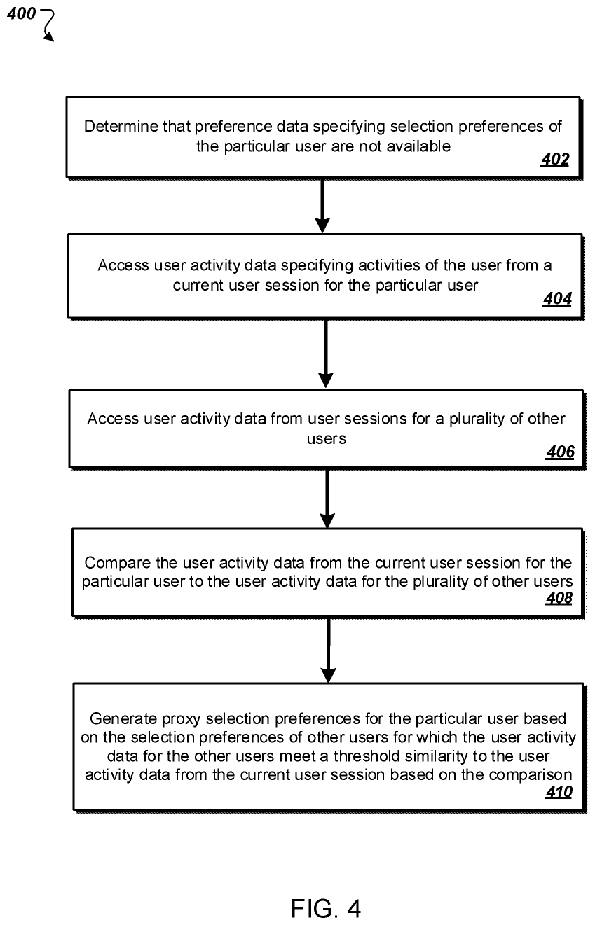

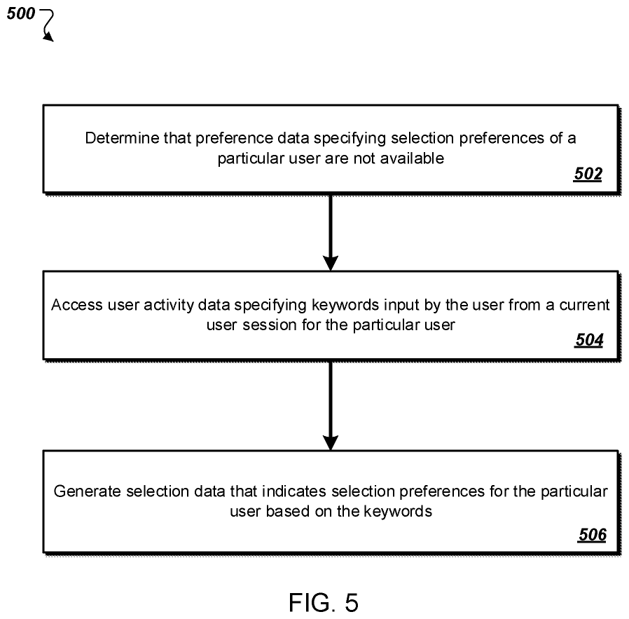

The process 300 accesses data that indicates selection preferences for a particular user (302). For example, the adjustment subsystem 130 of FIG. 1 can receive selection preferences from the user preferences store 132. In some implementations, accessing data that indicates selection preferences of the particular user process includes determining that preference data specifying selection preferences of the particular user are available, and in response to determining that the preference data specifying selection preferences of the particular user are available, accessing the preference data. If user selection preferences are not available, two example processes for generating proxy selection preferences and generating selection preferences based on key words from user data are further described below with process 400 of FIG. 4, and process 500 of FIG. 5, respectively.

The process 300 determines a first data set of first content items for presentation to the particular user independent of the selection preferences for the particular user (304). For example, the adjustment subsystem 130 of FIG. 1 can receive search results 111 responsive to the query 109 from the search engine 110. The search results 111 are ranked by the search engine 110 without accessing the selection preferences for the user from the user preferences store 132.

The process 300 determines a second data set of second content items for presentation to the particular user dependent on the selection preferences for the particular user (306). For example, the adjustment subsystem 130 of FIG. 1 can receive search results 111 responsive to the query 109 from the search engine 110, access the selection preferences for the user from the user preferences store 132, and adjust the results based on the selection preferences.

In some implementations, the second data set includes at least one second content item that has a ranking in the second data set that is boosted relative to a ranking that would have resulted independent of the selection preferences, and is determined to be a content item that the particular user will select. For example, the adjustment subsystem 130 of FIG. 1 can receive search results 111 responsive to the query 109 from the search engine 110 and based on the selection preferences for the user determine to increase the ranking of a particular result in the search results 111 that is determined to be a result the user will select.

In some implementations, boosting a ranking of one or more content items can include any change in the display of the one or more content items that are boosted. For example, if a list of recipes is shown, including a snippet of each recipe, the system can choose what subset of information to include for each recipe. If the user has a preference for a particular ingredient, the system processes the data such that the personalized item can include that particular ingredient in the snippet or highlight that ingredient, causing a change in display without a change in ordering.

In some implementations, determining that the at least one second content item is a content item that the particular user will select is based on data indicating prior selections of the particular user. For example, the adjustment subsystem 130 of FIG. 1 can receive data indicating prior selections for the particular user from the selection logs 117. If these prior selections indicate a user is likely to select a particular result, then that result may be adjusted. Additionally, or alternatively, determining that the at least one second content item is a content item that the particular user will select is based on data indicating prior selections of other users that have respective search histories that meet a similarity threshold to a search history of the particular user. For example, the adjustment subsystem 130 of FIG. 1 can receive data indicating prior user selections and respective search histories of other users from the query logs 114 and selection logs 117. From the data, the adjustment subsystem 130 or the search engine 110 analyzes the search histories for the particular user and other users to determine which search histories meet a similarity threshold to the search history of the particular user.

The process 300 generates a first display panel that will cause a user device to display the first data set of the first content items (308). For example, the adjustment subsystem 130 of FIG. 1 can generate a display panel for the search results 111 without changing a ranking of the results. For example, as shown in FIG. 2, the unadjusted result 124A-124N are shown as display panel 123.

The process 300 generates a second display panel that will cause a user device to display the second data set of the second content items (310). For example, the adjustment subsystem 130 of FIG. 1 can generate a display panel for the search results 111 after changing a ranking of the results based on the user selection preferences. For example, as shown in FIG. 2, the adjusted result 122A-122N are shown as display panel 121.

The process 300 provides the first display panel and the second display panel for simultaneous display on the user device to the user device (312). For example, as shown in FIG. 1, the adjustment subsystem 130 of FIG. 1 can provide the user device 106 with data to display on the user interface 106 the first display panel 121 with the adjusted results elements 122 (e.g., the second data set of second content items dependent on the selection preferences of the particular user) simultaneously with and adjacent to the second display panel 123 with the unadjusted results elements 124 (e.g., the first data set of first content items independent of the selection preferences of the particular user).

In some implementations, as shown in FIG. 2, the simultaneous display is a juxtaposition of the first display panel 202 and the second display panel 204. Alternatively, the display panels 202, 204, are shown one at a time, where the user would interact with each display panel to toggle between each display panel before selecting the preferred display panel. For example, a user could swipe, or click and drag with a mouse, over one display panel that is shown, and the system would then display the other display panel. The system can then allow the user to toggle between either the first display panel or the second display until a user a selection of the preferred display panel is received.

The process 300 provides data that displays a request to select one of the first display panel or the second display panel to the user device (314). For example, as shown in FIG. 2, the adjustment subsystem 130 of FIG. 1 can provide the user device 106 with data to display on the user interface 106 a request for the user to select the preferred display panel. In particular, the user interface 210 prompts the user to “Select a presentation that your prefer,” which enables the user to choose from a first display panel 202 (i.e., “A”) which includes adjusted results elements 203A-203N which are adjusted based on user selection preferences or other processes described herein, and a second display panel 204 (i.e., “B”) which includes unadjusted results elements 205A-205N. In this example, the application displays to the user, two selectable display panels simultaneously on the user device 106 of adjusted result elements 203 in a first display panel 202 and unadjusted result elements 205 in the second display panel 204.

The process 300 receives data indicating a selection of one of the first display panel or the second display panel from the user device (316). For example, the user of the user device 106 may prefer the adjusted result elements 203A-203N compared to the unadjusted result elements 205A-205N and selects on the display panel 202, either on the display panel 202 itself, or on the “A” indicator. After a user has selected the preferred display panel, the adjustment subsystem 130 receives the request and stores the user selection preference data in the user preference store 132.

In some implementations, in response to receiving, from the user device, data indicating the selection of the second display panel (e.g., the first display panel 121 with the adjusted results elements 122), the process 300 further includes providing, to the user device, data that displays an indication that the second display panel is based on the selection preferences of the particular user. For example, referring to FIG. 2, assume the user has selected display panel 202 (“A”) which includes adjusted result elements 122 which have been adjusted based on the user's selection preferences.

In some implementations, the data that indicates selection preferences of the particular user is based on location data. The location data is global positioning system (GPS) coordinates, map coordinates (e.g., latitude and longitude), or any other location information the system can recognize and use the location data to generate adjusted results based on the location data. For example, if a user searches for “Italian food” and the location data indicates that the user is located in the northeast portion City X, the adjusted results may adjust the result elements for Italian food restaurants in the northeast portion of City X to be shown first.

Additionally, or alternatively, the data that indicates selection preferences of the particular user is based on web history data. For example, the adjustment sub system 130 of FIG. 1 can access a particular user's web history from the selection logs 116 the system can use the user's web history to generate adjusted result elements. Additionally, or alternatively, the data that indicates selection preferences of the particular user is based on search history data. For example, the adjustment sub system 130 of FIG. 1 can access a particular user's search history from the query logs 114, and the system can use the search history to generate the adjusted results based.

In some implementations, the data that indicates selection preferences of the particular user is based on a combination of location data, web history data, search history data, or the like.

FIG. 4 is a flow diagram of another example process 400 for using a search query evaluation and an adjustment system. The process 400 is implemented, for example, by the adjustment subsystem 130 of FIG. 1. The process 400 is one example process for generating proxy selection preferences when user selection preferences data is not available for a particular user. Another example process of the adjustment subsystem 130 for generating selection preferences based on key words from user data when preference data specifying selection preferences of the particular user are not available is further described below with process 500 of FIG. 5.

The process 400 determines that preference data specifying selection preferences of the particular user are not available (402). For example, the adjustment subsystem 130 of FIG. 1 can request selection preferences from the user preferences store 132 and determine that selection preferences of the particular user are not available.

The process 400 accesses user activity data specifying activities of the user from a current user session for the particular user (404). For example, the adjustment subsystem 130 of FIG. 1 can obtain the user activity data for the particular user from the search engine 110, which can mine the user activity data from the query logs 114 and/or the selection logs 116 of the search history data 117. The user activity data can include data indicating the resulting actions of the particular user that are performed during a user session. For example, for a resource, data describing actions taken by the particular user after search results referencing the resource may be stored in the query logs 114 and selection logs 116.

The process 400 accesses user activity data from user sessions for a plurality of other users (406). For example, the adjustment subsystem 130 of FIG. 1 can obtain the user activity data from other users from the search engine 110, which can mine the user action data from the query logs 114 and/or the selection logs 116 of the search history data 117. The user activity data can include data indicating the resulting actions of the other users that are performed after selecting search result elements. For example, for a resource, data describing actions taken by users after search results referencing the resource may be stored in the query logs 114 and selection logs 116.

The process 400 compares the user activity data from the current user session for the particular user to the user activity data for the plurality of other users (408). For example, the adjustment subsystem 130 of FIG. 1 can compare the obtained activity data from the particular user and the other users received from the search engine 110 to determine which of the activity data of the users is similar to the particular user.

The process 400 generates proxy selection preferences for the particular user based on the selection preferences of other users for which the user activity data for the other users meet a similarity threshold to the user activity data from the current user session based on the comparison (410). For example, the adjustment subsystem 130 of FIG. 1 can determine, after comparing the activity data from the particular user and the other users to determine which of the activity data of the users is similar to the particular user, which user or user's activity data meets a similarity threshold. The threshold may be a fixed threshold, or may be an outlier threshold based on statistics for the action, e.g., greater than one standard deviation from the mean percentage of users that perform actions.

FIG. 5 is a flow diagram of an example process 500 for using a search query evaluation and an adjustment system. The process 500 is implemented, for example, by the adjustment subsystem 130 of FIG. 1. The process 500 is an example process for generating selection preferences when user selection preferences data is not available for a particular user.

The process 500 determines that preference data specifying selection preferences of the particular user are not available (502). For example, the adjustment subsystem 130 of FIG. 1 can request selection preferences from the user preferences store 132 and determine that selection preferences of the particular user are not available.

The process 500 accesses user activity data specifying keywords input by the user from a current user session for the particular user (504). For example, the adjustment subsystem 130 of FIG. 1 can obtain the user activity data for the particular user from the search engine 110, which can mine the user action data from the query logs 114 and/or the selection logs 116 of the search history data 117. The user activity data can include data indicating the specific keywords the particular user entered into a search query or queries that are performed during a current user session. For example, for a particular user activity, such as a search query, specific keywords used by the particular user may be stored in the query logs 114 and selection logs 116.

The process 500 generates selection data that indicates selection preferences for the particular user based on the keywords (506). For example, the adjustment subsystem 130 of FIG. 1 can use the specific keywords the particular user entered into a search query or queries that are performed during a current user session and generate selection data that indicates selection preferences for the particular user based on those keywords. For example, a user may enter query for “new music videos for Rock Star X.” The adjustment subsystem 130 can then generate selection preferences and adjust content related to “Rock Star X” and rank higher a particular “music video” for that musician. The selection preferences then are used to adjust the result elements for more than music videos, but may bring up content the particular user may be interested in regarding the musician, such as a fan based biography webpage, that has music videos or other information the particular user may be interested in. Thus, one display panel with the unadjusted result elements (i.e. unadjusted result elements 205 of FIG. 2) can show music videos for that musician, and the other display panel with the adjusted result elements (i.e. adjusted result elements 203 of FIG. 2) can show one music video of musician and the fan based webpage, and/or a social media home page for that particular musician. Then the particular user who sent the search can select which display panel they would prefer to see on other future queries.

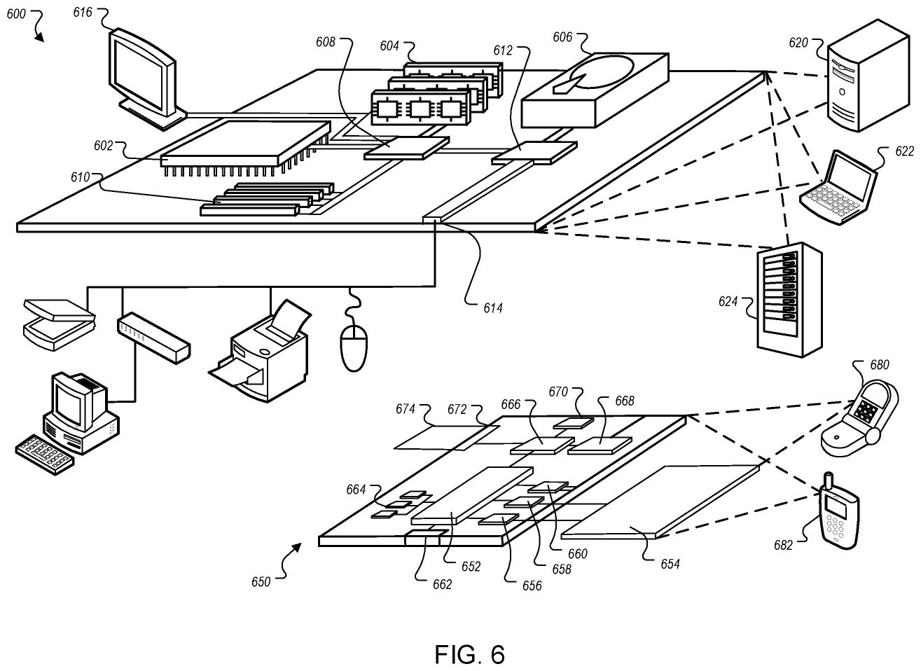

FIG. 6 is a block diagram of example computing devices 600 and 650 that are used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 600 is further intended to represent any other typically non-mobile devices, such as televisions or other electronic devices with one or more processers embedded therein or attached thereto. Computing device 650 is intended to represent various forms of mobile devices, such as personal digital assistants, cellular telephones, smartphones, and other computing devices. The components shown here, their connections and relationships, and their functions, are meant to be examples only, and are not meant to limit implementations of the disclosures described and/or claimed in this document.

Computing device 600 includes a processor 602, memory 604, a storage device 606, a high-speed controller 608 connecting to memory 604 and high-speed expansion ports 610, and a low-speed controller 612 connecting to low-speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a graphical user interface (GUI) on an external input/output device, such as display 616 coupled to high-speed controller 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low-speed controller 612 manages lower bandwidth-intensive operations. Such allocation of duties is an example only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed bus 614. The low-speed bus 614 (e.g., a low speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as computing device 650. Each of such devices may contain one or more of computing devices 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The computing device 650 may also be provided with a storage device, such as a micro-drive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the computing device 650, such as control of user interfaces, applications run by computing device 650, and wireless communication by computing device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of computing device 650 with other devices. External interface 662 may provide, for example, for wired communication (e.g., via a docking procedure) or for wireless communication (e.g., via Bluetooth® or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to computing device 650 through expansion interface 672, which may include, for example, a subscriber identification module (SIM) card interface. Such expansion memory 674 may provide extra storage space for computing device 650, or may also store applications or other information for computing device 650. Specifically, expansion memory 674 may include instructions to carry out or supplement the processes described above, and may include secure information also. Thus, for example, expansion memory 674 may be provide as a security module for computing device 650, and may be programmed with instructions that permit secure use of computing device 650. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Computing device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 668 (e.g., a radio-frequency transceiver). In addition, short-range communication may occur, such as using a Bluetooth®, WiFi, or other such transceiver (not shown). In addition, GPS receiver module 670 may provide additional wireless data to computing device 650, which may be used as appropriate by applications running on computing device 650.

Computing device 650 may also communicate audibly using audio codec 660, which may receive spoken information from a user and convert it to usable digital information. Audio codec 660 may likewise generate audible sound for a user, such as through a speaker, e.g., in a handset of computing device 650. Such sound may include sound from voice telephone calls, may include recorded sound (e.g., voice messages, music files, etc.) and may also include sound generated by applications operating on computing device 650.

The computing device 650 may be implemented in a number of different forms, as shown in the figure. For example, it may be implemented as a cellular telephone 680. It may also be implemented as part of a smartphone 682, personal digital assistant, or other mobile device.

In situations in which the systems discussed here collect personal information about users, or may make use of personal information, the users may be provided with an opportunity to control whether applications or features collect user information (e.g., information about a user's social network, social actions or activities, profession, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a user computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method performed by data processing apparatus, the method comprising:
accessing data that indicates selection preferences of a particular user;
determining, independent of the selection preferences of the particular user, a first data set of first content items for presentation to the particular user;
determining, dependent on the selection preferences of the particular user, a second data set of second content items for presentation to the particular user, wherein the second data set includes at least one second content item that:
has a ranking in the second data set that is boosted relative to a ranking that would have resulted independent of the selection preferences; and
is determined to be a content item that the particular user will select;
generating a first display panel that will cause a user device to display the first data set of the first content items;
generating a second display panel that will cause the user device to display the second data set of the second content items;
providing, to the user device, the first display panel and the second display panel for simultaneous display on the user device, wherein the simultaneous display is a juxtaposition of the first display panel and the second display panel;
providing, to the user device, data that displays a request to select one of the first display panel or the second display panel; and
receiving, from the user device, data indicating a selection of one of the first display panel or the second display panel.

2. The method of claim 1, wherein accessing data that indicates selection preferences of the particular user comprises:
determining that preference data specifying selection preferences of the particular user are available; and
in response to determining that the preference data specifying selection preferences of the particular user are available, accessing the preference data.

3. The method of claim 1, wherein accessing data that indicates selection preferences of the particular user comprises:
determining that preference data specifying selection preferences of the particular user are not available, and in response:
accessing user activity data from a current user session for the particular user, the user activity data specifying activities of the user;
accessing user activity data from user sessions for a plurality of other users;
comparing the user activity data from the current user session for the particular user to the user activity data for the plurality of other users; and
generating proxy selection preferences for the particular user based on the selection preferences of other users for which the user activity data for the other users meet a similarity threshold to the user activity data from the current user session based on the comparison.

4. The method of claim 1, wherein accessing data that indicates selection preferences of the particular user comprises:
determining that preference data specifying selection preferences of the particular user are not available, and in response:
accessing user activity data from a current user session for the particular user, the user activity data specifying keywords input by the user; and
generating, based on the keywords, selection data that indicates selection preferences for the particular user.

5. The method of claim 1, wherein determining that the at least one second content item is a content item that the particular user will select is based on data indicating prior selections of the particular user.

6. The method of claim 1, wherein determining that the at least one second content item is a content item that the particular user will select is based on data indicating prior selections of other users that have respective search histories that meet a similarity threshold to a search history of the particular user.

7. The method of claim 1, wherein the data that indicates selection preferences of the particular user is based on location data.

8. The method of claim 1, wherein the data that indicates selection preferences of the particular user is based on web history data.

9. The method of claim 1, wherein the data that indicates selection preferences of the particular user is based on search history data.

10. The method of claim 1, wherein in response to receiving, from the user device, data indicating the selection of the second display panel, the method further comprises:
providing, to the user device, data that displays an indication that the second display panel is based on the selection preferences of the particular user.

11. A system, comprising:
a data processing apparatus; and
a non-transitory computer readable storage medium in data communication with the data processing apparatus and storing instructions executable by the data processing apparatus and upon such execution cause the data processing apparatus to perform operations comprising:
accessing data that indicates selection preferences of a particular user;
determining, independent of the selection preferences of the particular user, a first data set of first content items for presentation to the particular user;
determining, dependent on the selection preferences of the particular user, a second data set of second content items for presentation to the particular user, wherein the second data set includes at least one second content item that:
has a ranking in the second data set that is boosted relative to a ranking that would have resulted independent of the selection preferences; and
is determined to be a content item that the particular user will select;
generating a first display panel that will cause a user device to display the first data set of the first content items;
generating a second display panel that will cause the user device to display the second data set of the second content items;
providing, to the user device, the first display panel and the second display panel for simultaneous display on the user device, wherein the simultaneous display is a juxtaposition of the first display panel and the second display panel;
providing, to the user device, data that displays a request to select one of the first display panel or the second display panel; and
receiving, from the user device, data indicating a selection of one of the first display panel or the second display panel.

12. The system of claim 11, wherein accessing data that indicates selection preferences of the particular user comprises:
determining that preference data specifying selection preferences of the particular user are available; and
in response to determining that the preference data specifying selection preferences of the particular user are available, accessing the preference data.

13. The system of claim 11, wherein accessing data that indicates selection preferences of the particular user comprises:
determining that preference data specifying selection preferences of the particular user are not available, and in response:
accessing user activity data from a current user session for the particular user, the user activity data specifying activities of the user;
accessing user activity data from user sessions for a plurality of other users;
comparing the user activity data from the current user session for the particular user to the user activity data for the plurality of other users; and
generating proxy selection preferences for the particular user based on the selection preferences of other users for which the user activity data for the other users meet a similarity threshold to the user activity data from the current user session based on the comparison.

14. The system of claim 11, wherein accessing data that indicates selection preferences of the particular user comprises:
determining that preference data specifying selection preferences of the particular user are not available, and in response:
accessing user activity data from a current user session for the particular user, the user activity data specifying keywords input by the user; and
generating, based on the keywords, selection data that indicates selection preferences for the particular user.

15. The system of claim 11, wherein determining that the at least one second content item is a content item that the particular user will select is based on data indicating prior selections of the particular user.

16. The system of claim 11, wherein determining that the at least one second content item is a content item that the particular user will select is based on data indicating prior selections of other users that have respective search histories that meet a similarity threshold to a search history of the particular user.

17. The system of claim 11, wherein the data that indicates selection preferences of the particular user is based on location data.

18. The system of claim 11, wherein the data that indicates selection preferences of the particular user is based on web history data.

19. The system of claim 11, wherein the data that indicates selection preferences of the particular user is based on search history data.

20. A non-transitory computer storage medium encoded with a computer program, the computer program comprising instructions that when executed by a data processing apparatus cause the data processing apparatus to perform operations comprising:
accessing data that indicates selection preferences of a particular user;
determining, independent of the selection preferences of the particular user, a first data set of first content items for presentation to the particular user;
determining, dependent on the selection preferences of the particular user, a second data set of second content items for presentation to the particular user, wherein the second data set includes at least one second content item that:
has a ranking in the second data set that is boosted relative to a ranking that would have resulted independent of the selection preferences; and
is determined to be a content item that the particular user will select;
generating a first display panel that will cause a user device to display the first data set of the first content items;
generating a second display panel that will cause the user device to display the second data set of the second content items;
providing, to the user device, the first display panel and the second display panel for simultaneous display on the user device, wherein the simultaneous display is a juxtaposition of the first display panel and the second display panel;
providing, to the user device, data that displays a request to select one of the first display panel or the second display panel; and
receiving, from the user device, data indicating a selection of one of the first display panel or the second display panel.
